(19) United States
(12) Patent Application Publication
(10) Pub. No.: US 2003/0032719 A1
(43) Pub. Date: Feb. 13, 2003

(54) Aqueous coating material that can be hardened thermally and/or by using actinic radiation and, the use thereof

(76) Inventor: Ekkehard Sapper, Rimpar (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/181,126

(22) PCT Filed: Jan. 30, 2001
(86) PCT No.: PCT/EP01/00972

(30) Foreign Application Priority Data
Feb. 3, 2000 (DE) 100 04 726.2

(51) Int. Cl. B05D 3/02; C08K 3/00

(52) U.S. Cl. 524/589; 427/385.5

(57) ABSTRACT

The invention relates to an aqueous coating material that can be hardened thermally and/or by using actinic radiation. Said coating material contains: A) at least one polyurethane, which is saturated, unsaturated and/or which is grafted with olefinically unsaturated compounds and ionically and/or non-ionically stabilized, is used as a binding agent; B) at least one cross-linking agent, and; C) at least one chromophoric and/or effect-producing pigment. The coating material is characterized in that hexamethylene diisocyanate and/or at least one polyisocyanate based on hexamethylene diisocyanate is/are used as the cross-linking agent (B), which is completely blocked with a mixture consisting of, with regard to the present isocyanate groups to be blocked, B1) 25 to 75 mol % of at least one malonic acid dialkyl ester, and of B2) 75 to 25 mol % of at least one dialkyl ketoxime. The invention also relates to the use of the aqueous coating substance for producing single and multilayer chromophoric and/or effect-producing paints on primed and non-primed substrates.

The present invention relates to a novel polyurethane-based aqueous coating material and to its use for producing single-coat and multicoat color and/or effect paint systems in automotive OEM finishing and automotive refinish, in industrial coating, including coil coating and container coating, in the coating of plastics, and in furniture coating.

Aqueous coating materials curable thermally and comprising a crosslinking agent, and an ionically and/or nonionically stabilized polyurethane which is saturated, unsaturated and/or grafted with olefinically unsaturated compounds and is based on aliphatic, cycloaliphatic, aliphatic-cycloaliphatic, aromatic, aliphatic-aromatic and/or cycloaliphatic-aromatic polyisocyanates, and the corresponding paint systems, are known, for example, from patent EP-A-0 089 497, DE-C-197 22 862 or DE-A-196 45 761. Also known is the use of polyisocyanates, blocked with dialkyl malonates or with dialkyl ketoximes, as crosslinking agents (cf. European patent EP-A-0 089 497). These known aqueous coating materials, especially the aqueous basecoat materials, and the single-coat or multicoat color and/or effect paint systems produced with them possess very good performance properties.

More and more owners of automobiles are nowadays acquiring high-pressure cleaners or hot-steam high-pressure cleaners in order to clean their motor vehicles. This type of cleaning, however, places considerably increased demands on what is known as the wet adhesion of all of the coats of the multicoat paint systems that are on the automobiles. The multicoat color and/or effect paint systems known to date, based on existing aqueous basecoat materials, may delaminate under these cleaning conditions. This may involve detachment of the clearcoat from the aqueous basecoat or of the aqueous basecoat from the surfacer coat. This problem is exacerbated when the aqueous basecoat materials have a high pigment content.

International patent application WO 94/22969 discloses a clearcoat material comprising as binder at least one hydroxyl-containing acrylate copolymer and as crosslinking agent, inter alia, polyisocyanates based on hexamethylene diisocyanate that are blocked with a mixture of dialkyl malonates and dialkyl ketoximes. The multicoat color and/or effect paint systems produced therewith exhibit good intercoat adhesion between clearcoat and aqueous basecoat, which is attributed to the use of the specific acrylate copolymers. Indications of an improvement in the adhesion properties of the aqueous basecoat through the use of specific block polyisocyanates cannot be inferred from this patent.

It is an object of the present invention to provide a novel aqueous coating material which is curable thermally, or thermally and with actinic radiation, and which is very highly suitable as an aqueous basecoat material or solid-color topcoat material for producing single-coat and multicoat color and/or effect paint systems with wet adhesion properties which satisfy the increased demands. The improvement in the wet adhesion properties should be ensured even when the aqueous basecoat materials or solid-color topcoat materials have high pigment contents. Furthermore, the otherwise excellent performance properties of the existing aqueous basecoat materials and solid-color topcoat materials ought not to be impaired. Not least, the improvement in wet adhesion properties ought also to accompany the use of any of a wide variety of clearcoats.

The invention accordingly provides the novel aqueous coating material curable thermally and/or with actinic radiation, which comprises

A) at least one ionically and/or nonionically stabilized polyurethane which is saturated, unsaturated and/or grafted with olefinically unsaturated compounds, as binder,

B) at least one crosslinking agent, and

C) at least one color and/or effect pigment,

using as crosslinking agent (B) hexamethylene diisocyanate and/or at least one polyisocyanate based on hexamethylene diisocyanate which is fully blocked with a mixture of, based on the isocyanate groups for blocking that are present,

B1) from 25 to 75 mol % of at least one dialkyl malonate and

B2) from 75 to 25 mol % of at least one dialkyl ketoxime;

and which is referred to below as “coating material of the invention”.

Further subject matter of the invention will emerge from the following description.

In the light of the prior art it was surprising and unforeseeable for the skilled worker that the object on which the present invention is based could be achieved by means of the specially selected crosslinking agent for use in accordance with the invention. Indeed, the expectation was more that only complex variation of the binder base would bring about the effect according to the invention. However, this objective was achieved by way of the comparatively more simple variation of the crosslinking agents, with the crosslinking agents selected being of surprisingly broad applicability.

The coating material of the invention is curable thermally and/or with actinic radiation.

In the context of the present invention, actinic radiation means electromagnetic radiation, such as visible light, UV radiation or X-rays, especially UV radiation, and corpuscular radiation, such as electron beams.

Where thermal curing and curing with actinic light are employed together in the context of one coating material, the terms “dual cure” and “dual-cure coating material” are also used.

The coating material of the invention may be a one-component (1K) system.

In the context of the present invention, a one-component (1K) system is a coating material curable thermally or thermally and with actinic radiation in which the binder and the crosslinking agent are present alongside one another, i.e., in one component. A prerequisite for this is that the two constituents crosslink with one another only at relatively high temperatures and/or on exposure to actinic radiation.

The inventively essential constituent of the coating material of the invention is at least one crosslinking agent (B). In accordance with the invention it comprises a hexamethylene diisocyanate and/or at least one polyisocyanate based on hexamethylene diisocyanate which is fully blocked with a mixture of, based on the isocyanate groups for blocking that are present,

B1) from 25 to 75, preferably from 30 to 70, more preferably from 35 to 65, with particular preference from 40 to 60, with very particular preference from 45 to 55, and in particular from 48 to 52 mol % of at least one dialkyl malonate and

B2) from 75 to 25, preferably from 70 to 30, more preferably from 65 to 35, with particular preference from 60 to 40, with very particular preference from 55 to 45, and in particular from 52 to 48 mol % of at least one dialkyl ketoxime.

Examples of suitable alkyl radicals are methyl, ethyl, propyl, butyl, pentyl, hexyl, heptyl, octyl, nonyl, decyl, undecyl, dodecyl or pentadecyl radicals, especially methyl and ethyl radicals.

Examples of highly suitable blocking agents (B₁) are dimethyl malonate, methyl ethyl malonate or diethyl malonate, of which the latter is particularly advantageous and is therefore used with preference in accordance with the invention.

Examples of highly suitable blocking agents (B2) are dimethyl ketoxime, methyl ethyl ketoxime or diethyl ketoxime, of which methyl ethyl ketoxime is particularly advantageous and therefore used with preference in accordance with the invention.

Examples of suitable polyisocyanates based on hexamethylene diisocyanate are polyurethane prepolymers containing isocyanate groups which have been prepared by reacting polyols such as propylene glycol with an excess of hexamethylene diisocyanate, and/or polyisocyanates containing isocyanurate, biuret, allophanate, iminooxadiazinedone, urethane, urea and/or uretdione groups. Preference is given to using polyisocyanates containing on average per molecule from 2.5 to 5 isocyanate groups and having viscosities of from 100 to 10 000, preferably from 100 to 5 000, mPas. Moreover, the polyisocyanates may have been given conventional hydrophilic or hydrophobic modification.

Very particular preference is given to using the polyurethane prepolymers containing isocyanate groups and also the mixtures of polyisocyanates containing uretdione and/or isocyanurate groups and/or allophanate groups, based on hexamethylene diisocyanate, such as are formed by catalytic oligomerization of hexamethylene diisocyanate using appropriate catalysts.

Viewed in terms of its method, preparation of the crosslinking agent (B) for use in accordance with the invention has no special features but instead takes place conventionally by reacting hexamethylene diisocyanate and/or the polyisocyanates based thereon with the blocking agents (B1) and (B2) in the molar proportions indicated above in at least one organic solvent that is inert toward isocyanate groups.

In the coating materials of the invention the crosslinking agents (B) for use in accordance with the invention are present in any of a very wide variety of amounts. The proportion is guided primarily by the material composition and the functionality of the binders (A) with respect to the crosslinking reaction. The skilled worker is therefore able to determine the proportion that is suitable in each case on the basis of his or her general art knowledge, with the assistance where appropriate of range finding tests, in a simple way. In accordance with the invention it is of advantage to use the crosslinking agents (B) in amounts such as are commonly used in aqueous basecoat materials or solid-color topcoat materials. The coating materials of the invention preferably contain the crosslinking agents (B) in an amount, based in each case on the coating material, of from 0.5 to 60%, more preferably from 1.0 to 50%, with particular preference from 1.5 to 40%, with very particular preference from 2.0 to 30%, and in particular from 2.5 to 20% by weight.

The further essential constituent of the coating material of the invention is at least one binder (A).

In accordance with the invention, said binder (A) comprises at least one ionically and/or nonionically stabilized polyurethane (A) which is saturated, unsaturated and/or grafted with olefinically unsaturated compounds.

Advantageously, depending on the nature of the stabilization, the polyurethane (A) for inventive use has an acid number or amine number of from 10 to 250 mg KOH/g (ionic stabilization or nonionic plus ionic stabilization) or of from 0 to 10 mg KOH/g (nonionic stabilization), an OH number of from 30 to 350 mg KOH/g, and a number average molecular weight of from 1 500 to 55 000 daltons.

The method of preparing the polyurethane (A) is arbitrary. It is preferably obtainable by preparing, in a first process step, a polyurethane prepolymer which contains at least one free isocyanate group.

The polyurethane prepolymer is of linear, branched or comb, but especially linear, construction. In this context the linear polyurethane prepolymer includes preferably two free isocyanate groups, especially two terminal free isocyanate groups. The branched or comb-constructed polyurethane prepolymers include preferably at least two, in particular more than two, free isocyanate groups, terminal free isocyanate groups being preferred.

In terms of method, the preparation of the polyurethane prepolymers for use in accordance with the invention has no special features but instead takes place, for example, as described in patent DE-C-197 22 862 , DE-A-196 45 761, EP-A-0 522 419 or EP-A-0 522 420, by reaction of at least one polyol, especially a diol, with at least one polyisocyanate, especially a diisocyanate, the isocyanate component being employed in a molar excess so as to give terminal free isocyanate groups.

For the preparation of the polyurethane prepolymers it is preferred to use diisocyanates and also, if desired, in minor amounts, polyisocyanates, for the purpose of introducing branches. In the context of the present invention, minor amounts are amounts which do not cause gelling of the polyurethane prepolymers during their preparation. This may also be prevented by using small amounts of monoisocyanates.

Examples of suitable diisocyanates are isophorone diisocyanate (i.e., 5-isocyanato-1-isocyanatomethyl-1,3,3-trimethylcyclohexane), 5-isocyanato-1-(2-iso-cyanatoeth-1-yl)-1,3,3-trimethylcyclohexane, 5-iso-cyanato-1-(3-isocyanatoprop-1-yl)-1,3,3-trimethylcyclo-hexane, 5-isocyanato-(4-isocyanatobut-1-yl) -1,3,3-tri-methyl-cyclohexane, 1-isocyanato-2-(3-isocyanatoprop-1-yl)cyclohexane, 1-isocyanato-2-(3-isocyanatoeth-1-yl)-cyclohexane, 1-isocyanato-2-(4-isocyanatobut-1-yl)-cyclohexane, 1,2-diisocyanatocyclobutane, 1,3-diiso-cyanatocyclobutane, 1,2-diisocyanatocyclopentane, 1,3-diisocyanatocyclopentane, 1,2-diisocyanatocyclo-hexane, 1,3-diisocyanatocyclohexane, 1,4-diisocyanato-cyclohexane, dicyclohexylmethane 2,4′-diisocyanate,trimethylene diisocyanate, tetramethylene diisocyanate, pentamethylene diisocyanate, hexamethylene diisocyanate, ethylethylene diisocyanate, trimethylhexane diisocyanate, heptanemethylene diisocyanate or diiso-cyanates derived from dimeric fatty acids, as marketed under the commercial designation DDI 1410 by the company Henkel and described in the patents DO 97/49745 and WO 97/49747, especially 2-heptyl-3,4-bis (9-iso-cyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis (3-isocyanatoprop-1-yl)cyclohexane, 1,2-, 1,4- or 1,3-bis-(4-isocyanatobut-1-yl)cyclohexane, liquid bis (4-iso-cyanatocyclohexyl)methane with a trans/trans content of up to 30% by weight, preferably 25% by weight, and in particular 20% by weight, as is described by the patents DE-A-44 14 032, GB-A-1220717, DE-A-16 18 795 or DE-A-17 93 785; tetramethylxylylidene diisocyanate (TMXDI® from CYTEC), tolylene diisocyanate, xylylene diisocyanate, bisphenylene diisocyanate, naphthylene diisocyanate or diphenylmethane diisocyanate.

Examples of suitable polyisocyanates based on the diisocyanates described above are isocyanato-containing polyurethane prepolymers, which have been prepared by reacting polyols with an excess of at least one of the above-described diisocyanates, and/or polyisocyanates containing isocyanurate, biuret, allophanate, iminooxadiazinedione, urethane, urea and/or uretdione groups. It is preferred to use polyisocyanates containing on average from 2.5 to 5 isocyanate groups per molecule and having viscosities of from 100 to 10 000, preferably from 100 to 5 000 mPas. Furthermore, the polyisocyanates may have been subjected to conventional hydrophilic or hydrophobic modification.

Very particular preference is given to the use of mixtures of polyisocyanates which contain uretdione and/or isocyanurate and/or allophanate groups and which are based on the above-described diisocyanates as formed by catalytic oligomerization of diisocyanates using appropriate catalysts.

Examples of suitable monoisocyanates are phenyl isocyanate, cyclohexyl isocyanate or stearyl isocyanate, or vinyl isocyanate, methacryloyl isocyanate, and/or 1-(1-isocyanato-1-methylethyl)-3-(1-methyl-ethenyl)benzene (TMI® from CYTEC).

Examples of suitable polyols are saturated or olefinically unsaturated polyesterpolyols which are prepared by reacting

unsulfonated or sulfonated saturated and/or unsaturated polycarboxylic acids or their esterifiable derivatives, alone or together with monocarboxylic acids, and

saturated and/or unsaturated polyols, alone or together with monools.

Examples of suitable polycarboxylic acids are aromatic, aliphatic and cycloaliphatic polycarboxylic acids. Preference is given to the use of aromatic and/or aliphatic polycarboxylic acids.

Examples of suitable aromatic polycarboxylic acids are phthalic acid, isophthalic acid, terephthalic acid, phthalic, isophthalic or terephthalic acid monosulfonate, or halophthalic acids, such as tetrachlorophthalic or tetrabromophthalic acid, among which isophthalic acid is advantageous and is therefore used with preference.

Examples of suitable acyclic aliphatic or unsaturated polycarboxylic acids are oxalic acid, malonic acid, succinic acid, glutaric acid, adipic acid, pimelic acid, suberic acid, azelaic acid, sebacic acid, undecanedicarboxylic acid or dodecanedicarboxylic acid, or dimeric fatty acids or maleic acid, fumaric acid or itaconic acid, of which adipic acid, glutaric acid, azelaic acid, sebacic acid, dimeric fatty acids and maleic acid are advantageous and are therefore used with preference.

Examples of suitable cycloaliphatic and cyclic unsaturated polycarboxylic acids are 1,2-cyclobutanedi-carboxylic acid, 1,3-cyclobutanedicarboxylic acid, 1,2-cyclopentanedicarboxylic acid, 1,3-cyclopentanedi-carboxylic acid, hexahydrophthalic acid, 1,3-cyclo-hexanedicarboxylic acid, 1,4-cyclohexanedicarboxylic acid, 4-methylhexahydrophthalic acid, tricyclo-decanedicarboxylic acid, tetrahydrophthalic acid or 4-methyltetrahydrophthalic acid. These dicarboxylic acids may be used both in their cis and in their trans form and also as a mixture of both forms.

Also suitable are the esterifiable derivatives of the abovementioned polycarboxylic acids, such as their monoesters or polyesters with aliphatic alcohols having 1 to 4 carbon atoms or hydroxy alcohols having 1 to 4 carbon atoms, for example. It is also possible to use the anhydrides of the abovementioned polycarboxylic acids, where they exist.

Together with the polycarboxylic acids it is also possible if desired to use monocarboxylic acids, such as, for example, benzoic acid, tert-butylbenzoic acid, lauric acid, isononanoic acid, fatty acids of naturally occurring oils, acrylic acid, methacrylic acid, ethacrylic acid or crotonic acid. The preferred monocarboxylic acid used is isononanoic acid.

Examples of suitable polyols are diols and triols, especially diols. Normally, triols are used alongside the diols in minor amounts in order to introduce branches into the polyester polyols.

Suitable diols are ethylene glycol, 1,2- or 1,3-propanediol, 1,2-, 1,3- or 1,4-butanediol, 1,2-, 1,3-,1,4- or 1,5-pentanediol, 1,2-, 1,3-, 1,4-, 1,5- or 1,6-hexanediol, neopentyl hydroxypivalate, neopentyl glycol, diethylene glycol, 1,2-, 1,3- or 1,4-cyclo-hexanediol, 1,2-, 1,3- or 1,4-cyclohexanedimethanol, trimethylpentanediol, ethylbutylpropanediol, the positionally isomeric diethyloctanediols 2-butyl-2-ethyl-1,3-propanediol, 2-butyl-2-methyl-1,3-propane-diol, 2-phenyl-2-methyl-1,3-propanediol, 2-propyl-2-ethyl-1,3-propanediol, 2-di-tert-butyl-1,3-propanediol, 2-butyl-2-propyl-1,3-propanediol, 1-dihydroxymethyl-bicyclo[2.2.1]heptane, 2,2-diethyl-1,3-propanediol,2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexane-diol, 2,4-dimethyl-2,4-pentanediol, 2,3-dimethyl-2,3-butanediol, 1,4-(2′-hydroxypropyl)benzene or 1,3-(2′-hydroxypropyl)benzene. These diols may also be used per se for the preparation of the polyurethanes (A) for inventive use.

Of these diols, hexanediol and neopentyl glycol are particularly advantageous and are therefore used with particular preference.

Examples of suitable triols are trimethylolethane, trimethylolpropane or glycerol, especially trimethylolpropane.

The abovementioned triols may also be used per se to prepare the polyurethanes (A) for inventive use (cf. patent EP-A-0 339 433).

If desired, minor amounts of monools may also be used. Examples of suitable monools are alcohols or phenols such as ethanol, propanol, n-butanol, sec-butanol, tert-butanol, amyl alcohols, hexanols, fatty alcohols, allyl alcohol, or phenol.

The polyesterpolyols may be prepared in the presence of small amounts of a suitable solvent as entrainer. Examples of entrainers used are aromatic hydrocarbons, such as especially xylene and (cyclo)aliphatic hydrocarbons, e.g., cyclohexane or methylcyclohexane.

Further examples of suitable polyols are polyesterdiols which are obtained by reacting a lactone with a diol. They are notable for the presence of terminal hydroxyl groups and repeating polyester fractions of the formula —(—CO—(CHR)ₘ—CH₂—O—)—. Here, the index m is preferably from 4 to 6 and the substituent R is hydrogen or an alkyl, cycloalkyl, or alkoxy radical. No substituent contains more than 12 carbon atoms. The total number of carbon atoms in the substituent does not exceed 12 per lactone ring. Examples are hydroxycaproic acid, hydroxybutyric acid, hydroxydecanoic acid, and/or hydroxystearic acid.

Preferred for the preparation of the polyesterdiols is the unsubstituted ###-caprolactone, where m is 4 and all substituents R are hydrogen. The reaction with lactone is started by low molecular mass polyols such as ethylene glycol, 1,3-propanediol, 1,4-butanediol, or dimethylolcyclohexane. It is also possible, however, to react other reaction components, such as ethylenediamine, alkyldialkanolamines, or else urea, with caprolactone. Other suitable diols of relatively high molecular mass are polylactamdiols, which are prepared by reacting, for example, ###-caprolactam with low molecular mass diols.

Further examples of suitable polyols include polyetherpolyols, especially those having a number-average molecular weight of from 400 to 5 000, in particular from 400 to 3 000. Examples of highly suitable polyetherdiols are polyetherdiols of the general formula H—(—O—(CHR²)ₒ—)ₚOH, where the substituent R² is hydrogen or a lower, unsubstituted or substituted alkyl radical, the index o is from 2 to 6, preferably from 3 to 4, and the index p is from 2 to 100, preferably from 5 to 50. Especially suitable examples are linear or branched polyetherdiols such as poly(oxyethylene) glycols, poly(oxypropylene) glycols, and poly(oxybutylene) glycols.

The polyetherdiols should, firstly, not introduce excessive amounts of ether groups, since otherwise the polyurethanes (A) for inventive use that are formed start to swell in water. Secondly, they may be used in amounts which ensure the nonionic stabilization of the polyurethanes (A). In that case they act as the functional nonionic groups (a3) described below.

The polyurethane (A) for inventive use comprises alternatively

(a1) functional groups convertible into cations by neutralizing agents and/or quaternizing agents, and/or cationic groups, especially ammonium groups,

or

(a2) functional groups convertible into anions by neutralizing agents, and/or anionic groups, especially carboxylic acid and/or carboxylate groups,

and/or

(a3) nonionic hydrophilic groups, especially poly-(alkylene ether) groups.

Examples of suitable functional groups (a1) for inventive use which are convertible into cations by neutralizing agents and/or quaternizing agents are primary, secondary or tertiary amino groups, secondary sulfide groups or tertiary phosphine groups, especially tertiary amino groups or secondary sulfide groups.

Examples of suitable cationic groups (a1) for inventive use are primary, secondary, tertiary or quaternary ammonium groups, tertiary sulfonium groups or quaternary phosphonium groups, preferably quaternary ammonium groups or quaternary ammonium groups, tertiary sulfonium groups, but especially tertiary sulfonium groups.

Examples of suitable functional groups (a2) for inventive use which are convertible into anions by neutralizing agents are carboxylic acid, sulfonic acid or phosphonic acid groups, especially carboxylic acid groups.

Examples of suitable anionic groups (a2) for inventive use are carboxylate, sulfonate or phosphonate groups, especially carboxylate groups.

Examples of suitable neutralizing agents for the functional groups (a1) convertible into cations are organic and inorganic acids such as formic acid, acetic acid, lactic acid, dimethylolpropionic acid, citric acid, sulfuric acid, hydrochloric acid, and phosphoric acid.

Examples of suitable neutralizing agents for the functional groups (a2) convertible into anions are ammonia, ammonium salts, such as ammonium carbonate or ammonium bicarbonate for example, and also amines, such as trimethylamine, triethylamine, tributylamine, dimethylaniline, diethylaniline, triphenylamine, dimethylethanolamine, diethylethanolamine, methyldiethanolamine, triethanolamine and the like, for example. Neutralization may take place in organic phase or in aqueous phase. A preferred neutralizing agent used is dimethylethanolamine.

The amount of neutralizing agent used overall in the coating composition of the invention is chosen so that from 1 to 100 equivalents, preferably from 50 to 90 equivalents, of the functional groups (a1) or (a2) of the polyurethane (A) for inventive use are neutralized.

Of these functional (potentially) ionic groups (a1) and (a2) and functional nonionic groups (a3), the (potentially) anionic groups (a2) are advantageous and are therefore used with particular preference.

The introduction of (potentially) anionic groups (a2) into the polyurethane molecules takes place by way of the incorporation of compounds which contain in the molecule at least one isocyanate-reactive group and at least one group capable of forming anions; the amount to be used may be calculated from the target acid number.

Examples of suitable compounds of this kind are those containing two isocyanate-reactive groups in the molecule. Suitable isocyanate-reactive groups are in particular hydroxyl groups and primary and/or secondary amino groups. Accordingly it is possible, for example, to use alkanoic acids having two substituents on the ### carbon atom. The substituent may be a hydroxyl group, an alkyl group, or, preferably, an alkylol group. These alkanoic acids have at least one, generally from 1 to 3, carboxyl groups in the molecule. They have 2 to about 25, preferably 3 to 10, carbon atoms. Examples of suitable alkanoic acids are dihydroxypropionic acid, dihydroxysuccinic acid, and dihydroxybenzoic acid. A particularly preferred group of alkanoic acids are the ###,###-dimethylolalkanoic acids of the general formula R³—C(CH₂OH)₂COOH, R³ being a hydrogen atom or an alkyl group having up to about 20 carbon atoms. Examples of especially suitable alkanoic acids are 2,2-dimethylolacetic acid, 2,2-dimethylol-propionic acid, 2,2-dimethylolbutyric acid, and 2,2-dimenthylolpentanoic acid. The preferred dihydroxyalkanoic acid is 2,2-dimethylolpropionic acid. Examples of compounds containing amino groups are ###,###-diaminovaleric acid, 3,4-diaminobenzoic acid, 2,4-diaminotoluenesulfonic acid, and 2,4-diaminodiphenyl ether sulfonic acid.

Nonionic stabilizing poly(oxyalkylene) groups (a3) may be introduced as lateral or terminal groups into the polyurethane molecules. For this purpose it is possible to use, for example, alkoxypoly(oxyalkylene) alcohols having the general formula R⁴O—(—CH₂—CHR⁵—O—)ᵣH, where R⁵ is an alkyl radical having 1 to 6 carbon atoms, R⁵ is a hydrogen atom or an alkyl radical having 1 to 6 carbon atoms, and the index r is a number between 20 and 75 (cf. patents EP-A-0 354 261 or EP-A-0 424 705).

The use of polyols, polyamines and amino alcohols brings about an increase in the molecular weight of the polyurethanes (A).

Suitable polyols for the chain extension are polyols having up to 36 carbon atoms per molecule, such as ethylene glycol, diethylene glycol, triethylene glycol, 1,2-propanediol, 1,3-propanediol, 1,4-butanediol, 1,2-butylene glycol, 1,6-hexanediol, trimethylolpropane, castor oil or hydrogenated castor oil, ditrimethylolpropane ether, pentaerythritol, 1,2-cyclohexanediol, 1,4-cyclohexanedimethanol, bisphenol A, bisphenol F, neopentyl glycol, neopentyl glycol hydroxypivalate, hydroxyethylated or hydroxypropylated bisphenol A, hydrogenated bisphenol A, or mixtures thereof (cf. patents EP-A-0 339 433, EP-A-0 436 941, EP-A-0 517 707).

Examples of suitable polyamines have at least two primary and/or secondary amino groups. Polyamines are essentially alkylene polyamines having 1 to 40 carbon atoms, preferably about 2 to 15 carbon atoms. They may carry substituents which have no hydrogen atoms that are reactive with isocyanate groups. Examples are polyamines having a linear or branched aliphatic, cycloaliphatic or aromatic structure and at least two primary amino groups.

Diamines include hydrazine, ethylenediamine, propylenediamine, 1,4-butylenediamine, piperazine, 1,4-cyclohexyldimethylamine, 1,6-hexamethylenediamine, trimethylhexamethylenediamine, methanediamine, isophoronediamine, 4,4′-diaminodicyclohexylmethane, and aminoethyleneethanolamine. Preferred diamines are hydrazine, alkyl- or cycloalkyldiamines such as propylenediamine and 1-amino-3-aminomethyl-3,5,5-trimethylcyclohexane.

It is also possible to use polyamines containing more than two amino groups in the molecule. In these cases, however, it should be ensured—for example, by using monoamines as well—that no crosslinked polyurethane resins are obtained. Polyamines of this kind which may be used are diethylenetriamine, triethylenetetramine, dipropylenediamine, and dibutylenetriamine. An example of a monoamine is ethylhexylamine (cf. patent EP-A-0 089 497).

Examples of suitable amino alcohols are ethanolamine or diethanolamine.

The polyurethanes (A) for inventive use may contain terminal and/or lateral olefinically unsaturated groups. Groups of this kind may be introduced, for example, with the aid of compounds containing at least one isocyanate-reactive group, especially hydroxyl group, and at least one vinyl group. Examples of suitable compounds of this kind are trimethylolpropane monoallyl ether and trimethylolpropane mono(meth)-acrylate.

The polyurethanes (A) for inventive use may be grafted with ethylenically unsaturated compounds. Examples of suitable polyurethanes (A) for inventive use, in the form of graft copolymers, are known from patents EP-A-0 521 928, EP-A-0 522 420, EP-A-0 522 419 or EP-A-0 730 613.

The method of preparing the polyurethanes (A) for inventive use has no special features but instead takes place in accordance with the customary and known methods such as those described in the prior art cited at the outset.

The proportion of the polyurethanes (A) for inventive use in the coating materials of the invention may vary likewise extremely widely and is guided primarily by the intended use of the coating materials and by the functionality of the polyurethanes (A) with respect to the crosslinking reaction with the crosslinking agent (B). In accordance with the invention it is of advantage to use the amounts as described in the prior art cited at the outset.

The third inventively essential constituent of the coating material of the invention is at least one color and/or effect pigment.

The pigments may comprise organic or inorganic compounds. On the basis of this large number of appropriate pigments, therefore, the coating material, especially the aqueous basecoat and solid-color topcoat material, particularly the aqueous basecoat material, of the invention ensures a universal breadth of application and permits the realization of a large number of color shades and optical effects.

Effect pigments which may be used include metal flake pigments such as commercial aluminum bronzes, aluminum bronzes chromated in accordance with DE-A-36 36 183, and commercial stainless steel bronzes, and also nonmetallic effect pigments, such as pearlescent pigments and interference pigments, for example. For further details, reference is made to Römpp Lexikon, Lacke und Druckfarben, Georg Thieme Verlag, 1998, pages 176, “effect pigments”, and pages 380 and 381 “metal oxide-mica pigments” to “metal pigments”.

Examples of suitable inorganic color pigments are titanium dioxide, iron oxides, sicotrans yellow, and carbon black. Examples of suitable organic color pigments are thioindigo pigments, indanthrene blue, Cromophthal red, Irgazine orange and Heliogen green.

For further details, reference is made to Römpp, op. cit., pages 180 and 181, “iron blue pigments” to “black iron oxide”, pages 451 to 453 “pigments” to “pigment volume concentration”, page 563 “thioindigo pigments”, and page 567 “titanium dioxide pigments”.

The pigment content of the coating material of the invention may vary. extremely widely and is guided primarily by the opacity of the pigments, the desired shade, and the desired optical effect. In the coating material of the invention, the pigments are present in an amount of preferably from 0.5 to 50, more preferably from 0.5 to 45, with particular preference from 0.5 to 40, with very particular preference from 0.5 to 35, and in particular from 0.5 to 30% by weight, based in each case on the overall weight of the aqueous basecoat material of the invention. The pigment/binder ratio, i.e., the ratio of the pigments to the polyurethanes (A) of the invention and any other binders that may be present, may also vary extremely widely. This ratio is preferably from 6.0:1.0 to 1.0:50, more preferably from 5:1.0 to 1.0:50, with particular preference from 4.5:1.0 to 1.0:40, with very particular preference from 4:1.0 to 1.0:30, and in particular from 3.5:1.0 to 1.0:25.

The above-described constituents of the coating material of the invention are present in solution and/or dispersion in an aqueous medium. The aqueous medium comprises essentially water. The aqueous medium may contain minor amounts of organic solvents, neutralizing agents, crosslinking agents (B) and/or customary coatings additives and/or other dissolved solid, liquid or gaseous, organic and/or inorganic, low and/or high molecular mass substances. In the context of the present invention, the term “minor amount” means an amount which does not destroy the aqueous character of the aqueous medium. The aqueous medium may alternatively be straight water.

In addition to the crosslinking agents (B) described above that are for use in accordance with the invention, the coating material of the invention may additionally comprise at least one further crosslinking agent.

Examples of suitable further crosslinking agents are amino resins, resins or compounds containing anhydride groups, resins or compounds containing epoxide groups, tris(alkoxycarbonylamino)triazines, resins or compounds containing carbonate groups, blocked and/or nonblocked polyisocyanates, beta-hydroxyalkylamides, and compounds containing on average at least two groups capable of transesterification, examples being reaction products of malonic diesters and polyisocyanates or of esters and partial esters of polyhydric alcohols of malonic acid with monoisocyanates, as described in European patent EP-A-0 596 460. Of these it is preferred to use the epoxide compounds, the amino resins, the tris(alkoxycarbonylamino)triazines and/or the betahydroxyalkylamides. Crosslinking agents of this kind are well known to the skilled worker and are offered as commercial products by numerous companies.

Depending on the reactivity of the further crosslinking agent, it may be added directly to the coating materials of the invention, producing what is known as a one-component system. If, however, it is a particularly reactive crosslinking agent, such as a polyisocyanate or an epoxide, it is generally not added to the coating materials of the invention until shortly before use. The result in this case is what is known as a two-component or multicomponent system.

Where the coating materials of the invention are to be curable not only thermally but also with actinic radiation (dual cure), they comprise customary and known constituents which can be activated with actinic radiation. With particular preference, UV light is employed. Examples of suitable constituents which can be activated with actinic radiation are (meth)acryloyl-, allyl-, vinyl- or dicyclopentadienyl-functional (meth)acrylate copolymers or polyether acrylates, polyester acrylates, unsaturated polyester acrylates, epoxy acrylates, urethane acrylates, amino acrylates, melamine acrylates, silicone acrylates, or the corresponding methacrylates.

The coating material of the invention may further comprise reactive diluents for the thermal curing or for the curing with actinic radiation.

Examples of suitable reactive diluents for thermal curing are oligomeric polyols obtainable by hydroformylation and subsequent hydrogenation from oligomeric intermediates themselves obtained by metathesis reactions of acyclic monoolefins and cyclic monoolefins; examples of suitable cyclic monoolefins are cyclobutene, cyclopentene, cyclohexene, cyclooctene, cycloheptene, norbonene or 7-oxanorbonene; examples of suitable acyclic monoolefins are contained in hydrocarbon mixtures which are obtained in petroleum processing by cracking (C₅ cut); examples of suitable oligomeric polyols for use in accordance with the invention have a hydroxyl number of from 200 to 450, a number average molecular weight Mn of from 400 to 1 000, and a mass average molecular weight Mw of from 600 to 1 100.

Further examples of suitable polyols are branched, cyclic and/or acyclic C₉-C₁₆ alkanes functionalized with at least two hydroxyl groups, especially diethyloctanediols.

Further examples of polyols for use are hyperbranched compounds having a tetrafunctional central group, derived from ditrimethylolpropane, diglycerol, ditrimethylolethane, pentaerythritol, tetrakis(2-hydroxy-ethyl)methane, tetrakis(3-hydroxypropyl)methane or 2,2-bishydroxymethyl-1,4-butanediol (homopentaeryth-ritol). These reactive diluents may be prepared by the customary and known methods of preparing hyperbranched and dendrimeric compounds. Suitable synthesis methods are described, for example, in patents WO 93/17060 or WO 96/12754, or in the book by G. R. Newkome, C. N. Moorefield and F. Vögtle, “Dendritic Molecules, Concepts, Syntheses, Perspectives”, VCH, Weinheim, New York, 1996.

Suitable radiation-curable reactive diluents include polyfunctional, ethylenically unsaturated compounds of low molecular mass. Examples of suitable such compounds are esters of acrylic acid with polyols, such as neopentyl glycol diacrylate, trimethylolpropane triacrylate, pentaerythritol triacrylate or pentaerythritol tetraacrylate; or reaction products of hydroxyalkyl acrylates with polyisocyanates, especially aliphatic polyisocyanates.

Additionally to the above-described constituents, the coating material of the invention may comprise further customary and known binders.

Examples of customary and known binders are oligomeric and polymeric, thermally curable poly(meth)acrylates or acrylate copolymers that are of linear and/or branched and/or block, comb and/or random construction, especially those described in patent DE-A-197 36 535 or DE-A-197 41 554; polyesters, especially those described in patent DE-A-40 09 858 or DE-A-44 37 535; alkyds, acrylated polyesters, polylactones, polycarbonates, polyethers, epoxy resin-amine adducts, (meth)acrylate-diols, partially hydrolyzed polyvinyl esters, or polyureas, of which the acrylate copolymers and/or the polyesters are particularly advantageous.

The coating material of the invention may otherwise comprise customary coatings additives in effective amounts. The nature and amount of the additives are guided in particular by the intended use of the coating material of the invention. It is important that these additives are not volatile under the conditions of processing and application of the coating material of the invention.

Examples of suitable additives are:

organic and inorganic fillers such as chalk, calcium sulfates, barium sulfate, silicates such as talc or kaolin, silicas, oxides such as aluminum hydroxide or magnesium hydroxide, nanoparticles, or organic fillers such as textile fibers, cellulose fibers, polyethylene fibers or wood flour;

UV absorbers;

free-radical scavengers;

crosslinking catalysts;

slip additives;

polymerization inhibitors;

defoamers;

emulsifiers, especially nonionic emulsifiers such as alkoxylated alkanols, polyols, phenols and alkylphenols or anionic emulsifiers such as alkali metal salts or ammonium salts of alkanecarboxylic acids, alkanesulfonic acids and sulfo acids of alkoxylated alkanols, polyols, phenols and alkylphenols;

wetting agents such as siloxanes, fluorine compounds, carboxylic monoesters, phosphates, polyacrylic acids and their copolymers, or polyurethanes;

adhesion promoters;

leveling agents;

film-forming auxiliaries such as cellulose derivatives;

flame retardants;

rheology control additives, such as those known from the patents WO 94/22968, EP-A-0 276 501, EP-A-0 249 201, WO 97/12945; crosslinked polymeric microparticles, as disclosed for example in EP-A-0 008 127; inorganic phyllosilicates, such as aluminum-magnesium silicates, sodium-magnesium and sodium-magnesium-fluorine-lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride or ethylene-maleic anhydride copolymers and their derivatives or hydrophobically modified ethoxylated urethanes or polyacrylates; or

photoinitiators, such as photoinitiators of the Norrish II type, whose mechanism of action is based on an intramolecular variant of the hydrogen abstraction reactions as occur diversely in the case of photochemical reactions; by way of example, reference may be made here to Römpp Chemie Lexikon, 9th expanded and revised edition, Georg Thieme Verlag Stuttgart, Vol. 4, 1991.

Further examples of suitable coatings additives are described in the textbook “Lackadditive” [Additives for coatings] by Johan Bieleman, Wiley-VCH, Weinheim, N.Y., 1998.

Viewed in terms of its method, the preparation of the coating material of the invention has no special features but instead took place by the dispersing of its constituents in the aqueous medium, in which context primary or secondary dispersion methods and also customary and known mixing equipment such as stirred tanks, dissolvers, stirred mills, or extruders are employed. For example, refer to the prior art cited at the outset.

The coating material of the invention, especially the aqueous basecoat material of the invention, is outstandingly suitable for producing multicoat color and/or effect paint systems on primed and unprimed substrates by the wet-on-wet technique. Additionally, the coating material, especially solid-color topcoat material, of the invention is outstandingly suitable for producing single-coat color and/or effect paint systems.

The coating material of the invention exhibits particular advantages in its use as an aqueous basecoat material as part of the wet-on-wet technique, wherein the aqueous basecoat material is applied to the primed or unprimed substrate and dried, but not cured, a clearcoat material is subsequently applied to the aqueous basecoat film, and the resulting clearcoat film is cured together with the aqueous basecoat film, thermally or both thermally and with actinic radiation (dual cure).

Suitable substrates are all surfaces for coating which are not damaged by curing of the films present thereon using heat, or heat and actinic radiation in combination (dual cure); for example, metals, plastics, wood, ceramic, stone, textile, fiber assemblies, leather, glass, glass fibers, glass wool and rock wool, mineral-bound and resin-bound building materials, such as plasterboard and cement slabs or roof shingles, and composites of these materials. Accordingly, the multicoat paint systems of the invention are suitable for applications outside those of automotive OEM finishing and automotive refinish, as well. In this context they are particularly suitable for the coating of furniture and for industrial application, including coil coating and container coating. In the context of industrial applications they are suitable for coating virtually all parts for private or industrial use, such as radiators, domestic appliances, small metal parts such as nuts and bolts, hubcaps, wheel rims, or packaging.

In the case of electrically conductive substrates it is possible to use primers, which are prepared in a customary and known manner from electrodeposition coating materials. Both anodic and cathodic electrodeposition coating materials are suitable for this purpose, but especially cathodics. Normally, especially in the painting of automobiles, a surfacer coat or antistonechip primer coat, which may be regarded as part of the primer, is applied over the electrocoat.

It is also possible to coat, bond or seal parts made of primed or unprimed plastics, for example, ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations to DIN 7728T1). In the case of unfunctionalized and/or apolar substrate surfaces, these may be subjected prior to coating in a known manner to a pretreatment, such as with a plasma or by flaming, or may be provided with a water-based primer.

The aqueous basecoat materials of the invention may be applied by any standard method, such as spraying, knifecoating, brushing, flowcoating, dipping, impregnating, trickling or rolling, for example. The substrate to be coated may itself be at rest, with the application device or unit being moved. Alternatively, the substrate to be coated, especially a coil, may be moved, with the application unit being at rest relative to the substrate or being moved appropriately. Where the aqueous basecoat materials of the invention include constituents which can be activated with actinic radiation, application is conducted preferably in the absence of light. These application methods may of course also be used for the application of the clearcoat film as part of the wet-on-wet technique of the invention.

The applied aqueous basecoat films and clearcoat films may be cured thermally or both thermally and with actinic radiation in a conventional manner—where appropriate following a certain rest period serving for leveling films and/or the evaporation of volatile constituents.

In terms of method, thermal curing has no special features but instead uses the customary and known temperatures in the range from room temperature to 200° C., curing times in the range from one minute to three hours, and equipment such as radiant heaters or forced air ovens.

The curing with actinic radiation also has no special features in terms of its method, but instead takes place in a customary and known manner by irradiation with UV lamps and/or electron beam sources, preferably under inert gas.

In the case of conjoint curing of the dual-cure aqueous basecoat films of the invention with the clearcoat films, thermal curing and actinic radiation curing may be employed simultaneously or in alternation. Where the two curing methods are used in alternation, it is possible, for example, to commence with thermal curing and to end with actinic radiation curing. In other cases it may prove advantageous to commence and to end with actinic radiation curing. The skilled worker is able to determine the curing method most advantageous for the case in hand on the basis of his or her general knowledge in the art, with or without the assistance of simple preliminary tests.

In this context it is found to be a further particular advantage of the aqueous basecoat material of the invention that, in the context of the wet-on-wet technique, all customary and known clearcoat materials may be combined with the aqueous basecoat film of the invention.

Examples of suitable known one-component (1K), two-component (2K) or multicomponent (3K, 4K) clearcoat materials are known from the patents DE-A-42 04 518, US-A-5,474,811, US-A-5,356,669, US-A-5,605,965, WO 94/10211, WO 94/10212, WO 94/10213, EP-A-0 594 068, EP-A-0 594 071, EP-A-0 594 142, EP-A-0 604 992, WO 94/22969, EP-A-0 596 460 or WO 92/22615.

One-component (1K) clearcoat materials comprise, as is known, hydroxyl-containing binders and crosslinking agents such as blocked polyisocyanates, tris-(alkoxycarbonylamino)triazines and/or amino resins. In a further variant they comprise polymers containing lateral carbamate and/or allophanate groups as binders and amino resins modified with carbamate and/or with allophanate as crosslinking agents (cf. US-A-5,474,811, US-A-5,356,669, US-A-5,605,965, WO 94/10211, WO 94/10212, WO 94/10213, EP-A-0 594 068, EP-A-0 594 071 or EP-A-0 594 142).

Two-component (2K) or multicomponent (3K, 4K) clearcoat materials comprise as essential constituents, as is known, hydroxyl-containing binders and polyisocyanate crosslinking agents, which are stored separately until they are used.

Examples of suitable powder clearcoat materials are known, for example, from the German patent DE-A-42 22 194 or from the BASF Lacke +Farben AG product information bulletin “Pulverlacke” [powder coating materials], 1990.

The essential constituents of powder clearcoat materials are, as is known, binders containing epoxide groups, and polycarboxylic acids as crosslinking agents.

Examples of suitable powder slurry clearcoat materials are known, for example, from the U.S. patent US-A-4,268,542 and from the German patent applications DE-A-195 18 392.4 and DE-A-196 13 547, or are described in the German patent application DE-A-198 14 471.7, unpublished at the priority date of the present specification.

Powder slurry clearcoat materials, as is known, comprise powder clearcoat materials dispersed in an aqueous medium.

UV-curable clearcoat materials are disclosed, for example, in the patents EP-A-0 540 884, EP-A-0 568 967 or US-A-4,675,234.

Within the multicoat paint system of the invention, the thickness of the individual coats may vary widely. In accordance with the invention, however, it is of advantage for the aqueous basecoat film to have a thickness of from 5 to 25 μm, in particular from 7 to 20 μm, and for the clearcoat film to have a thickness of from 15 to 120 μm, preferably from 40 to 80 μm, and in particular from 60 to 70 μm.

The single-coat and multicoat paint systems of the invention have outstanding optical, mechanical, and chemical properties. For instance, they are free from any surface defects such as shrinkage (wrinkling). Moreover, they possess particularly high hiding power and outstanding optical effects, especially metallic effects.

In particular, no delamination of the coats can be observed during hot-steam high-pressure cleaning in the case of the inventive multicoat paint systems, owing to their outstanding wet adhesion properties.

### EXAMPLES

### Examples 1 and 2 (Inventive) and C1 (Comparative)

The preparation and use of inventive aqueous basecoat materials (examples 1 and 2) and of a noninventive aqueous basecoat material (example C1)

For the inventive and comparative examples the following ingredients were provided/prepared:

1. Crosslinking agent (B):

70% strength solution in methyl ethyl ketone of the isocyanurate of hexamethylene diisocyanate blocked with 50 mol % of diethyl malonate and 50 mol % of methyl ethyl ketoxime, based in each case on the isocyanate groups originally present.

2. Polyurethane dispersion (A):

The polyurethane dispersion (A) was prepared in accordance with the instructions specified in German patent DE-A-44 37 535 on page 7 lines 21 to 34, “B Preparation of an aqueous polyurethane dispersion” from 248.82 parts by weight of a polyester diol, prepared from 1.81 mol of a dimer fatty acid (Pripol® 1009 from Unichema; dimer content at least 98% by weight, trimer content not more than 2% by weight, monomer content traces at most), 0.82 mol of isophthalic acid, 0.61 mol of hexanediol and 0.61 mol of neopentyl glycol, 2.64 parts by weight of neopentyl glycol, 15.27 parts by weight of dimethylolpropionic acid, 77.07 parts by weight of m-tetramethylxylylidene diisocyanate, 13.16 parts by weight of trimethylolpropane and 8.41 parts by weight of dimethylethanolamine, and was adjusted to a solids content of 31% by weight.

3. Secondary aqueous acrylate dispersion:

The secondary aqueous acrylate dispersion was prepared exactly as described in German patent patent DE-A-44 37 535 on page 8 lines 25 to 49, “E Preparation of an aqueous polyacrylate dispersion”. Its solids content was 40% by weight.

4. Aqueous solution of a polyester:

The aqueous solution of a polyester was prepared as in the instructions specified in German patent patent DE-A-44 37 535 on page 7 lines 6 to 19, “Preparation of an aqueous polyester resin solution” from 97.8 parts by weight of neopentyl glycol, 62 parts by weight of hexahydrophthalic anhydride, 229 parts by weight of dimer fatty acid Pripol® 1009, 111 parts by weight of hexanediol, 102.9 parts by weight of trimellitic anhydride and 2.3 parts by weight of dimethylethanolamine using 20 parts by weight of xylene (azeotrope former) and 20 parts by weight of butyl Cellosolve (cosolvent) and adjusted with water to a solids content of 60% by weight.

5. Metallic pigment:

65% suspension of aluminum flakes from Eckart.

6. Melamine resin solution:

Maprenal® VMF 3924 (70%) from Clariant.

7. Rheological aid:

2% aqueous suspension of a phyllosilicate; Laponite® RD from Laporte.

8. Neutralizing agent:

10% aqueous solution of dimethylethanolamine.

The aqueous basecoat materials were prepared by mixing the constituents indicated in table 1.

TABLE 1
The material composition of the inventive
aqueous basecoat materials (examples 1 and 2) and
of the noninventive aqueous basecoat
material C1

| | Examples: | | |
|---|---|---|---|
| | 1 | 2 | C1 |
| Constituent No. | (% by wt.) | (% by wt.) | (% by wt.) |
| 1 | 7.4 | 3.7 | — |
| 2 | 33.4 | 33.4 | 33.4 |
| 3 | 6.4 | 6.4 | 6.4 |
| 4 | 4.3 | 4.3 | 4.3 |
| 5 | 4.8 | 4.8 | 4.8 |
| 6 | — | 3.7 | 7.4 |
| 7 | 36.1 | 36.1 | 36.1 |
| 8 | 0.6 | 0.6 | 0.6 |
| Butyl glycol | 2 | 2 | 2 |
| Isopropoxypropanol | 3 | 3 | 3 |
| Butoxypropanol | 2 | 2 | 2 |

To test the performance properties of the aqueous basecoat materials of table 1, test panels measuring 10×20 cm were prepared in a conventional manner. To this end, steel panels (body panels) which had been coated with a conventional cathodic electrodeposition coating, and baked, were coated with a commercial low-build surfacer (Ecoprime® 60 from BASF Coatings AG; anthracite-colored), after which the resulting surfacer film was flashed off at 20° C. and a relative humidity of 65% for 5 minutes and dried at 80° C. in a forced air oven for five minutes. The surfacer coat had a dry film thickness of 15 μm after this process.

After the cooling of the test panels to 20° C., the aqueous basecoat materials of table 1 were applied, flashed off at 20° C. and a relative atmospheric humidity of 65% for five minutes, and dried in a forced air oven at 80° C. for five minutes, so that the dried basecoat films had a dry film thickness of approximately 15 μm.

After the test panels had again been cooled to 20° C. the basecoat films were overcoated with a powder slurry clearcoat material in accordance with international patent application WO 96/32452. The resultant powder slurry clearcoat films were flashed off at 20° C. and a relative atmospheric humidity of 65% for 3 minutes and dried in a forced air oven at 55° C. for five minutes.

The dry film thickness of the resultant clearcoat films was from 55 to 57 μm.

Following the application of all three films they were baked together at 135° C. for 30 minutes to give the inventive multicoat paint system of examples 1 and 2 and the noninventive multicoat paint system of example C1.

Prior to testing, the test panels were stored in a controlled-climate area at 23° C. and a relative atmospheric humidity of 50% for 24 hours.

It was found that the noninventive multicoat paint system matched the inventive ones in its overall appearance, in its chemical resistance, yellowing resistance, weathering stability, and in its scratch resistance, but that it was inferior to the inventive ones in its wet adhesion properties.

The wet adhesion properties were determined in accordance with the Volvo boil test, which is known to those in the art. In this test, the test panels were immersed vertically in water so as to be 50% covered. The water was brought to boiling and held at boiling for 2 hours. Evaporation losses were compensated. Thereafter the test panels were removed from the boiling water and, in order to prevent regeneration, were immediately placed in water conditioned to ambient temperature (maximum storage period: 1 hour).

The test panels were subjected to the following tests in the order stated:

1. stonechip testing SAEJ 400 (VDA [German Carmakers Association] ball shot) (cf. also Römpp Lexikon Lacke und Druckfarben, Georg Thieme Verlag, Stuttgart, N.Y., “Stonechip test”, page 540);

2. crosshatch (2 mm) on the part of the metal panel that had come into contact with boiling water and on the part of the metal panel that had come into contact with the steam; and

3. cross-cut (peel test).

The area hit by stonechips, the crosshatching and the cross-cut were overstuck with Tesaband adhesive tape. The tape was pressed on firmly and then pulled off sharply toward the body of the tester.

In the case of the noninventive multicoat paint system of example C1, this resulted in extensive detachment, whereas the inventive multicoat paint systems of examples 1 and 2 did not detach.

1. An aqueous coating material curable thermally, or both thermally and with actinic radiation, comprising
A) at least one ionically and/or nonionically stabilized polyurethane which is saturated, unsaturated and/or grafted with olefinically unsaturated compounds, as binder,
B) at least one crosslinking agent, and
C) at least one color and/or effect pigment,
characterized in that crosslinking agents (B) used comprise hexamethylene diisocyanate and/or at least one polyisocyanate based on hexamethylene diisocyanate which is fully blocked with a mixture of, based on the isocyanate groups for blocking that are present,
B1) from 25 to 75 mol % of at least one dialkyl malonate and
B2) from 75 to 25 mol % of at least one dialkyl ketoxime.

2. The coating material of claim 1, characterized in that the polyisocyanate used comprises at least one polyurethane prepolymer containing isocyanate groups which has been prepared by reacting polyols with an excess of hexamethylene diisocyanate, and/or at least one polyisocyanate containing isocyanurate, biuret, allophanate, iminooxadiazinedone, urethane, urea and/or uretdione groups.

3. The coating material of claim 1 or 2, characterized in that, based on the isocyanate groups for blocking that are present, 50 mol % of the blocking agent B1) and 50 mol % of the blocking agent B2) are used.

4. The coating material of one of claims 1 to 3, characterized in that the ionically and/or nonionically stabilized polyurethane (A) which is saturated, unsaturated and/or grafted with olefinically unsaturated compounds comprises alternatively
(a1) functional groups convertible into cations by neutralizing agents and/or quaternizing agents, and/or cationic groups, especially ammonium groups,
or
(a2) functional groups convertible into anions by neutralizing agents, and/or anionic groups, especially carboxylic acid and/or carboxylate groups,
and/or
(a3) nonionic hydrophilic groups, especially poly(alkylene ether) groups.

5. The coating material of one of claims 1 to 4, characterized in that it comprises as additional crosslinking agents (B) at least one epoxide compound containing at least two epoxide groups per molecule, at least one amino resin, at least one tris(alkoxycarbonylamino)triazine and/or at least one beta-hydroxyalkylamide.

6. The use of the aqueous coating material of one of claims 1 to 5 for producing single-coat or multicoat color and/or effect paint systems for automotive OEM finishing and automotive refinish, industrial coating, including coil coating and container coating, the coating of plastics, and furniture coating.

7. The use according to claim 6, characterized in that the aqueous coating material is used as aqueous basecoat material and solid-color topcoat material in automotive OEM finishing and automotive refinish.

8. A process for producing a single-coat or multicoat color and/or effect paint system by applying at least one coat of the aqueous coating material of one of claims 1 to 5 to a primed or unprimed substrate and subjecting the resultant wet film(s) to thermal curing or curing with heat and actinic light.

9. A process for producing a multicoat color and/or effect paint system by the wet-on-wet technique, by
(I) applying an aqueous basecoat film to a primed or unprimed substrate,
(II) flashing off and predrying the resulting aqueous basecoat film,
(III) applying a clearcoat film to the aqueous basecoat film, and
(IV) curing the two wet films thermally or with heat and actinic light, characterized in that the aqueous basecoat material used comprises the aqueous coating material of one of claims 1 to 5.

10. Single-coat or multicoat color and/or effect paint systems for automotive OEM finishing and automotive refinish, industrial coating, including coil coating and container coating, the coating of plastics, and furniture coating, producible using the aqueous coating material of one of claims 1 to 5 and/or by the process of claim 9.
